(19) United States
(12) Patent Application Publication
(10) Pub. No.: US 2015/0117398 A1
(43) Pub. Date: Apr. 30, 2015

(54) REDUCED LATENCY DURING CELLULAR REDIRECTION

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/065,353

(22) Filed: Oct. 28, 2013

(51) Int. Cl. H04W 76/06; H04W 36/00

(52) U.S. Cl. CPC H04W 76/06; H04W 36/0005
USPC 370/331

(57) ABSTRACT

A user equipment (UE) may achieve faster cellular redirection, which reduces latency of the redirection, and improves throughput and user perception during redirection. In some instances, the UE may speed up the redirection by determining whether a connection release message with redirection information indicating a target radio access technology (RAT), a target cell and/or a target frequency has been received. The UE modifies a connection release complete procedure when the redirection information is received.

### TECHNICAL FIELD

Aspects of the present disclosure relate generally to wireless communication systems, and more particularly, to reducing latency during redirection from one radio access technology (RAT) to another RAT.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining whether a connection release message with redirection information indicating a target radio access technology (RAT), a target cell and/or a target frequency has been received. The method may also include modifying a connection release complete procedure when the redirection information is received.

According to one aspect of the present disclosure, a method for wireless communication includes transmitting a connection release message with redirection information indicating a target RAT, a target cell and/or a target frequency. The method also includes transmitting parameters for modifying a connection release complete procedure.

According to another aspect of the present disclosure, an apparatus for wireless communication includes means for determining whether a connection release message with redirection information indicating a target radio access technology (RAT), a target cell and/or a target frequency has been received. The apparatus may also include means for modifying a connection release complete procedure when the redirection information is received.

According to another aspect of the present disclosure, an apparatus for wireless communication includes means for transmitting a connection release with redirection information indicating a target RAT, a target cell and/or a target frequency. The apparatus may also include means for transmitting parameters for modifying a connection release complete procedure.

According to one aspect of the present disclosure, an apparatus for wireless communication includes a memory and a processor(s) coupled to the memory. The processor(s) is configured to determine whether a connection release message with redirection information indicating a target radio access technology (RAT), a target cell and/or a target frequency has been received. The processor(s) is further configured to modify a connection release complete procedure when the redirection information is received.

According to one aspect of the present disclosure, an apparatus for wireless communication includes a memory and a processor(s) coupled to the memory. The processor(s) is configured to transmit a connection release message with redirection information indicating a target RAT, a target cell and/or a target frequency. The processor(s) is further configured to transmit parameters for modifying a connection release complete procedure.

According to one aspect of the present disclosure, a computer program product for wireless communication in a wireless network includes a computer readable medium having non-transitory program code recorded thereon. The program code includes program code to determine whether a connection release message with redirection information indicating a target radio access technology (RAT), a target cell and/or a target frequency has been received. The program code also includes program code to modify a connection release complete procedure when the redirection information is received.

According to one aspect of the present disclosure, a computer program product for wireless communication in a wireless network includes a computer readable medium having non-transitory program code recorded thereon. The program code includes program code to transmit a connection release with redirection information indicating a target RAT, a target cell and/or a target frequency. The program code also includes program code to transmit parameters for modifying a connection release complete procedure.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a call flow of a typical network.

FIG. 6 illustrates a call flow of a radio resource control (RRC) procedure of a typical network.

FIG. 7 illustrates call flow of a radio resource control (RRC) procedure for reducing latency of redirection according to some aspects of the disclosure.

FIG. 8 illustrates another call flow of a radio resource control (RRC) procedure for reducing latency of redirection by adjusting a time interval between RRC connection release messages according to some aspects of the disclosure.

FIG. 9 is a block diagram illustrating a wireless communication method for performing faster redirection according to aspects of the present disclosure.

FIG. 10 is a block diagram illustrating another wireless communication method for performing faster redirection according to aspects of the present disclosure.

FIG. 11 is a block diagram illustrating an example of a hardware implementation for an apparatus employing a processing system.

FIG. 12 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

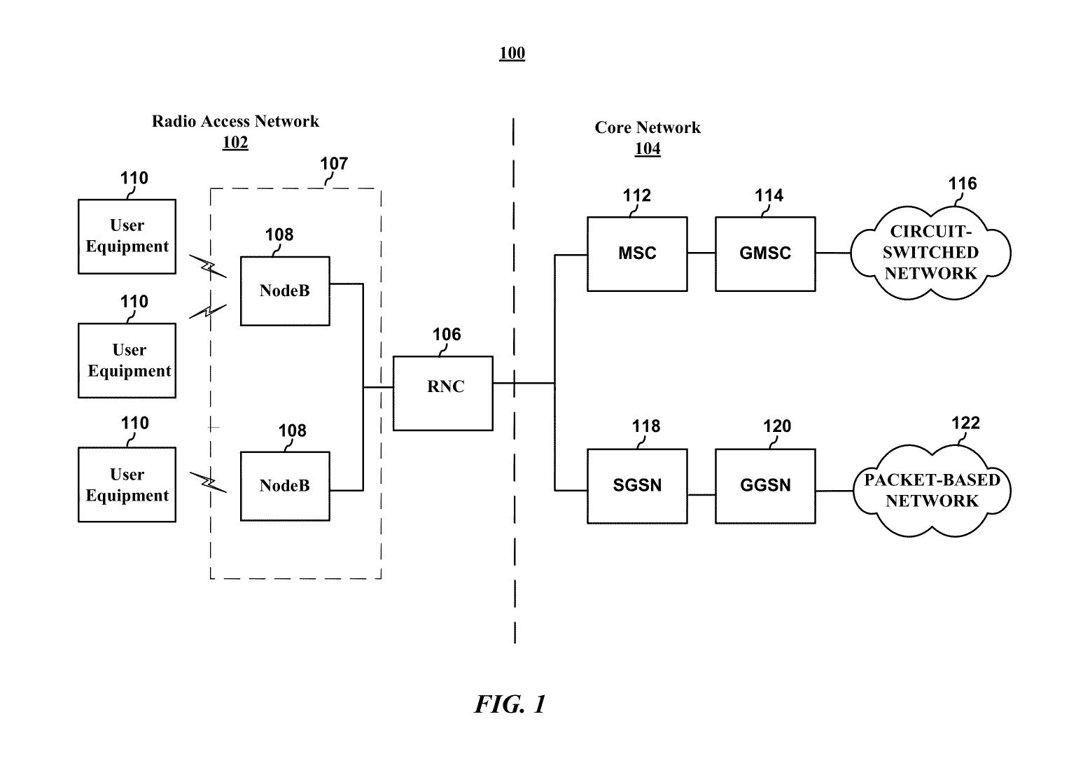

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 supports packet-data services with a serving general packet radio service (GPRS) support node (SGSN) 118 and a gateway GPRS support node (GGSN) 120. GPRS is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

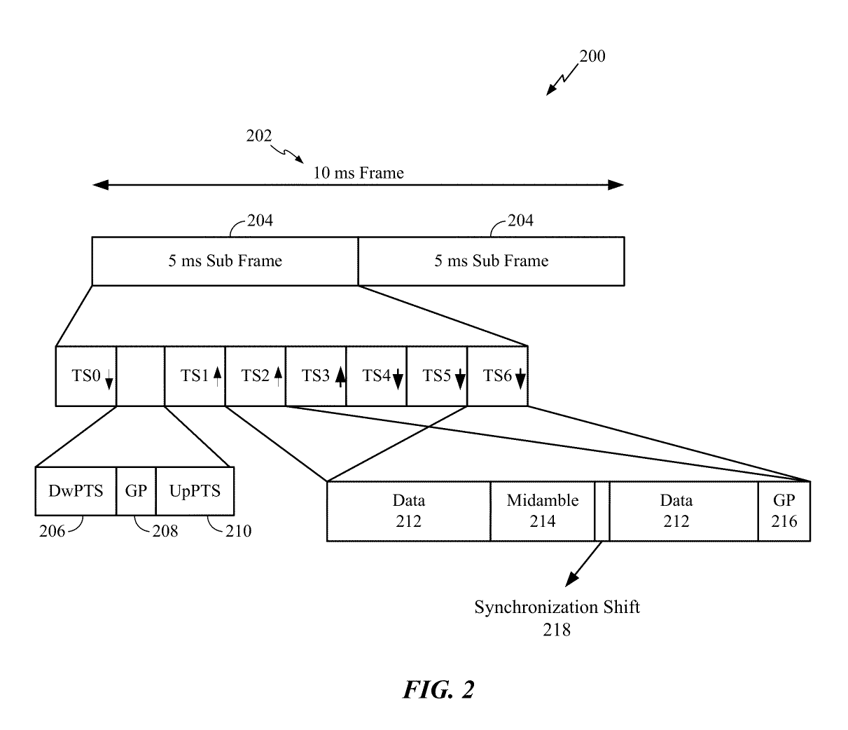

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

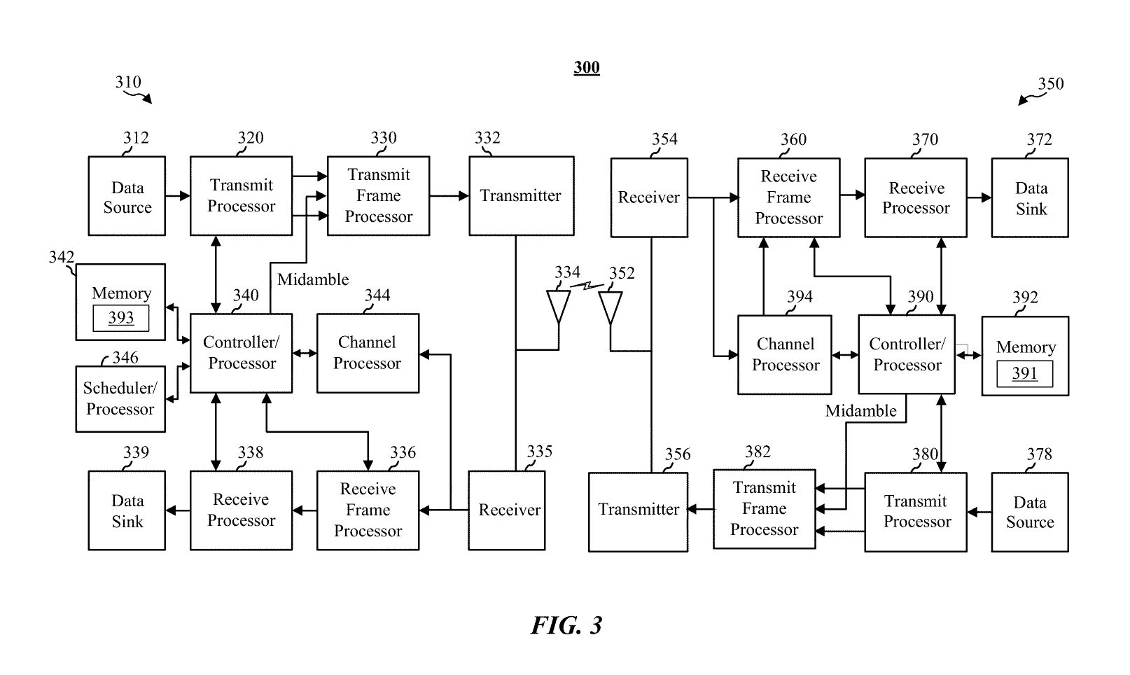

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a connection release modifying module 391 which, when executed by the controller/processor 390, configures the UE 350 to modify a radio resource control procedure based on aspects of the present disclosure. Similarly, the memory 342 of the node B 310 may store a connection release modifying module 393 which, when executed by the controller/processor 340, configures the node B 310 to perform a radio resource control procedure based on aspects of the present disclosure. A scheduler/processor 346 at the node B 310 may be used to allocate resources to the UEs and schedule downlink and/or uplink transmissions for the UEs.

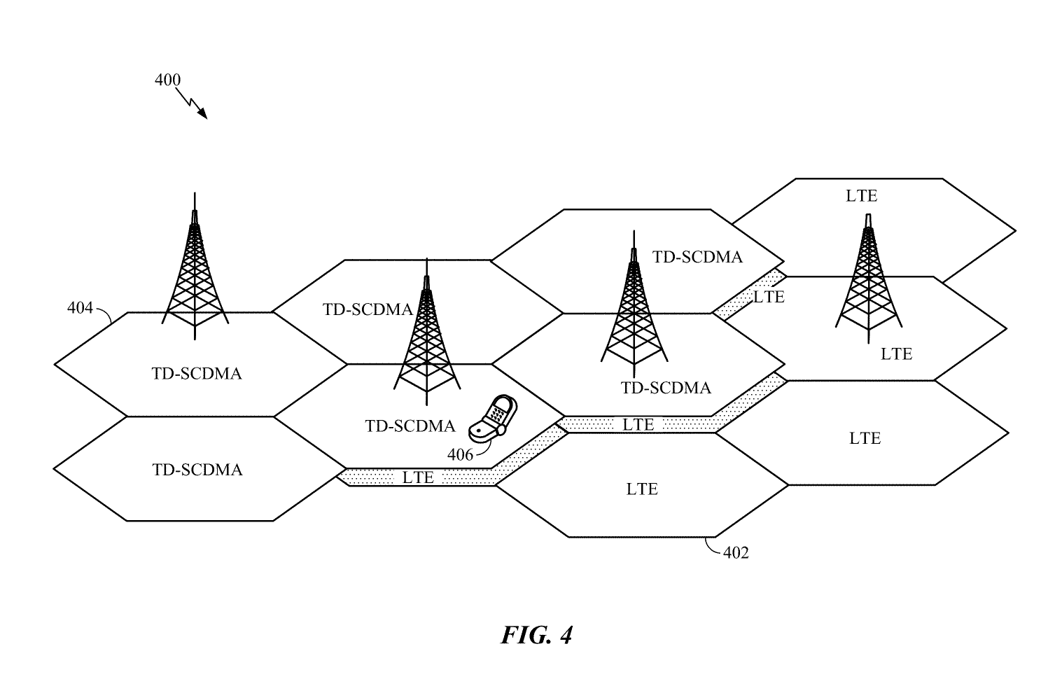

FIG. 4 illustrates coverage of a newly deployed network, such as an LTE network and also coverage of a more established network, such as a TD-SCDMA network. A geographical area 400 may include LTE cells 402 and TD-SCDMA cells 404. A user equipment (UE) 406 may move from one cell, such as a TD-SCDMA cell 404, to another cell, such as an LTE cell 402. The movement of the UE 406 may specify a handover or a cell reselection.

The handover or cell reselection may be performed when the UE moves from a coverage area of a TD-SCDMA cell to the coverage area of an LTE cell, or vice versa. A handover or cell reselection may also be performed when there is a coverage hole or lack of coverage in the TD-SCDMA network or when there is traffic balancing between the TD-SCDMA and LTE networks. As part of that handover or cell reselection process, while in a connected mode with a first system (e.g., TD-SCDMA) a UE may be specified to perform a measurement of a neighboring cell (such as LTE cell). For example, the UE may measure the neighbor cells of a second network for signal strength, frequency channel, and base station ID. The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Reduced Latency During Redirection

Aspects of the disclosure are directed to reducing latency of redirection from one radio access technology (RAT) to another RAT, such as time division-code division multiple access (TD-CDMA). In some aspects, the redirection may be from a frequency or cell of one RAT to a frequency or cell of the same RAT.

Redirection from one RAT to another RAT is commonly used to perform operations such as load balancing or circuit-switched fallback from one RAT to another RAT. For example, one of the RATs may be long term evolution (LTE) while the other RAT may be universal mobile telecommunications system-frequency division duplexing (UMTS FDD), universal mobile telecommunications system-time division duplexing (UMTS TDD), or global system for mobile communications (GSM).

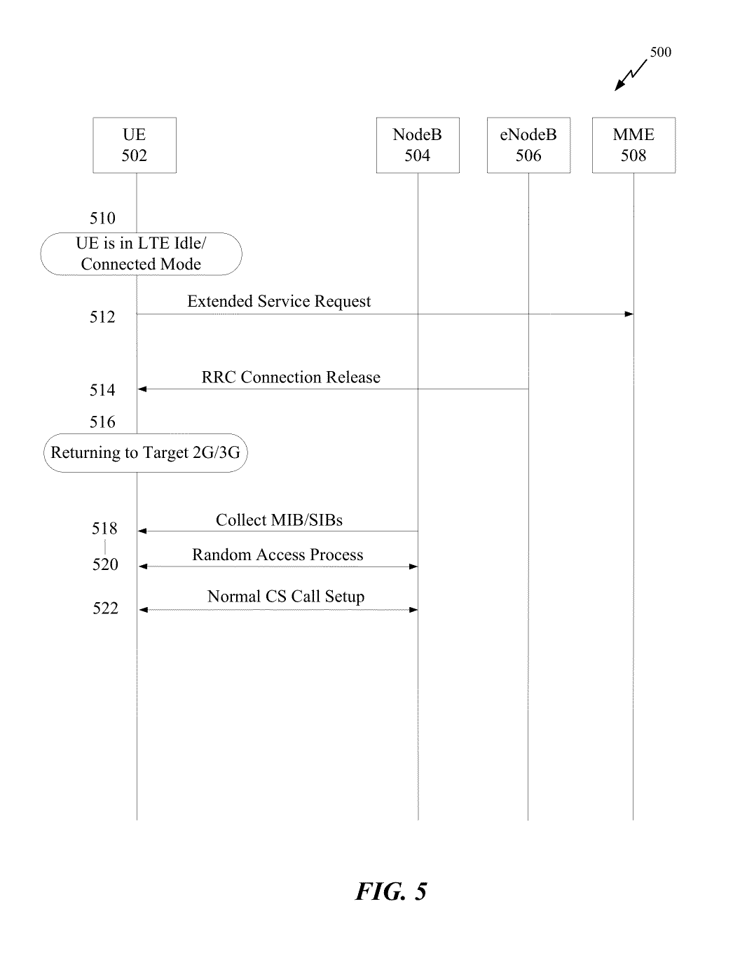

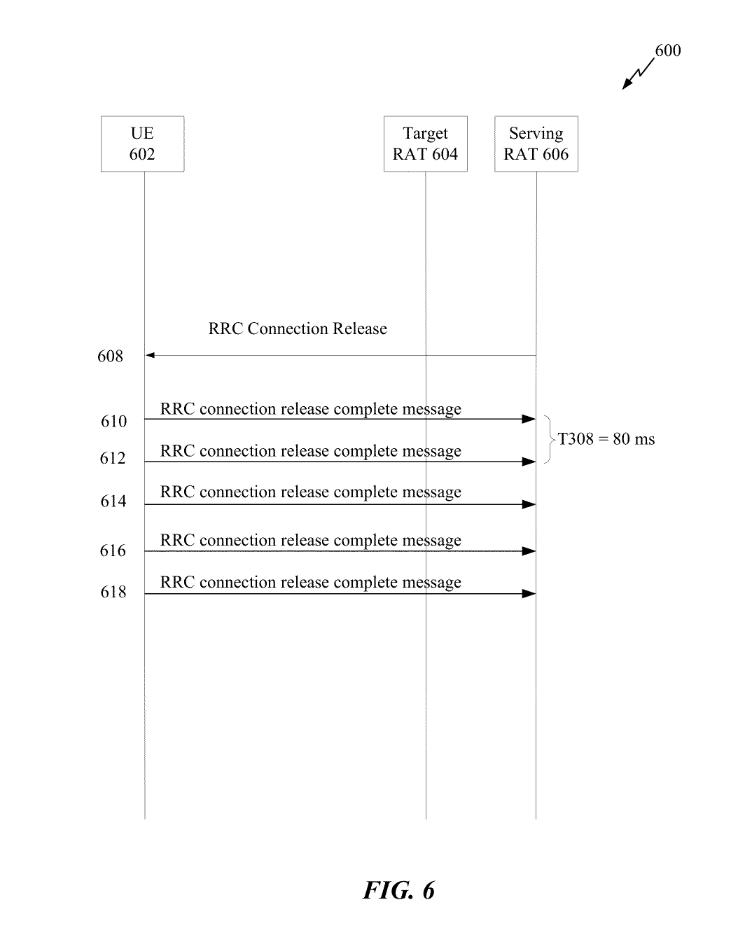

Circuit-switched fallback (CSFB) is a feature that enables multimode user equipment (UE) to provide available circuit-switched (CS) voice services. Multimode UEs refer to UEs that are capable of communicating on a first RAT while connected to a second RAT. In one configuration, the first RAT is a third/second generation (3G) mobile phone technology (3G/2G), such as TD-SCDMA, and the second RAT is LTE or vice versa. For example, a circuit-switched fallback capable UE may initiate a mobile-originated (MO) circuit-switched voice-call while on LTE. The initiated voice call may result in the UE being moved to a circuit-switched capable radio access network (RAN), such as 3G or 2G for a circuit-switched voice-call setup. A circuit-switched fallback capable UE may also be paged for a mobile-terminated (MT) voice call while on a specific RAT. The page may result in the UE being moved to another RAT for circuit switched voice call setup. An exemplary CSFB operation is illustrated by FIGS. 5 and 6.

FIG. 5 is a call flow diagram 500 illustrating a typical network operation. A UE 502 may be engaged in communications with a TD-SCDMA NodeB 504, and/or an LTE eNodeB (or base station) 506. In FIG. 5, the UE communicates with a mobility management entity (MME) 508 via the eNodeB 506. At time 510, the UE 502 is in idle mode or connected mode in the LTE network. At time 512, the UE 502 transmits an extended service request to the MME 508. The extended service request may be an indicator for a mobile-originated (MO) or mobile-terminated (MT) circuit-switched fallback (CSFB) call. For example, the extended service request may indicate a circuit-switched fallback call is desired.

At time 514, the eNodeB 506 transmits a connection release message to the UE 502, such as a radio resource control (RRC) connection release message. The RRC connection release message may be without any 2G/3G redirection information. A fast return flag may also be transmitted with a true value at time 514. Further, other information, such as but not limited to cell quality, may be transmitted at time 514. At time 516, the UE 502 returns to the 2G/3G network. At time 518, the TD-SCDMA NodeB 504 transmits a request to the UE 502 to collect the master information block (MIB) and the system information blocks (SIBs). At time 520, the UE 502 and the TD-SCDMA NodeB 504 are in communication with each other to perform a random access process. At time 522, the UE 502 and the TD-SCDMA NodeB 504 perform a normal circuit-switched (CS) call setup.

When a UE is in a connected mode (e.g., serving RAT connected mode) an RRC procedure may be implemented to facilitate redirection from the first RAT (e.g., LTE or TD-SCDMA) to a second RAT (e.g., TD-SCDMA or LTE). The RRC procedure may also be implemented to facilitate redirection from a frequency or cell of the first RAT to a different frequency or cell of the first RAT. During the RRC procedure, the UE may receive a communication (e.g., an RRC connection release message) from a serving RAT and transmit a response (e.g., RRC connection release complete message) to the network. The RRC connection release message may include redirection information indicating target RAT parameters. The redirection information may include an identified target RAT, the target RAT frequency, a target RAT cell ID and/other redirection parameters. The UE may attempt to camp or tune the radio frequency of the UE to the target RAT and perform an acquisition procedure. In some configurations, the UE may attempt to camp on a cell on the indicated target RAT frequency. An exemplary RRC procedure is illustrated by FIG. 6.

FIG. 6 illustrates a call flow 600 of an RRC procedure of a typical network. Before the UE 602 moves to the target RAT/frequency/cell 604, the UE completes the RRC procedure. During the RRC procedure, the UE 602 receives the RRC connection release message, at time 608, from a serving RAT 606, and transmits a response (e.g., RRC connection release complete message) to the network.

The RRC connection release message may include parameters defined by a network. For example, the RRC connection release message may define a number, e.g., N308 that represents the number of times RRC connection release complete messages may be sent by the UE in response to the RRC connection release message. In one configuration, the UE may send the RRC connection release complete message up to N308+1 times, upon expiration of a timer (e.g., T308).

In some configurations, the network may define the timer. For example, the timer T308 may be set to 40 ms, 80 ms, 160 ms, 320 ms or other specified time. In one configuration, the timer may be set to a default time of 160 ms.

As a result of the delay associated with the timer and the delay associated with sending multiple RRC connection release complete messages, redirection latency is unnecessarily increased. For example, the redirection latency may be increased up to 2.56 seconds. The calculated latency (i.e., 2.56 seconds) is a product of an interval (320 ms) between transmission of the RRC connection release complete messages and a number (8) of RRC connection release complete messages (i.e., 320 ms*8). The interval between the transmission of the RRC connection release complete messages and the number of RRC connection release complete messages may be indicated by the network in the RRC connection release message. A longer latency degrades throughput during redirection and negatively impacts user perception.

Conventionally, the UE 602 transmits multiple (e.g., 5 or 6) RRC connection release complete messages to the serving RAT 606. For example, the UE 602 may transmit an RRC connection release complete message at times 610, 612, 614, 616 and 618. The interval between consecutive RRC connection release complete messages may be a delay (e.g., T308=80 ms) that is configured by the network. The UE 602 may tune to the target RAT, the target cell on the target RAT and/or the target RAT frequency after the RRC connection release complete messages are transmitted by the UE 602.

When the UE receives an RRC connection release message that does not include redirection information indicating a target RAT (i.e., normal call release), the UE performs the conventional RRC connection release procedure. For example, the UE may send N308+1 RRC connection release complete messages. Each of the N308+1 RRC connection release complete messages are sent upon expiration of the timer T308. In this case, the UE moves to an idle mode after the RRC connection release complete messages are sent.

In general, RRC connection release complete messages are not acknowledged by a network. To mitigate the lack of acknowledgment, the UE 602 transmits multiple RRC connection release complete messages to ensure the RRC connection release complete messages are received. While sending multiple RRC connection release complete messages may be adequate for a normal call release, the multiple messages may increase latency of a redirection procedure. The increase in latency is especially detrimental to redirections associated with a fast return to LTE.

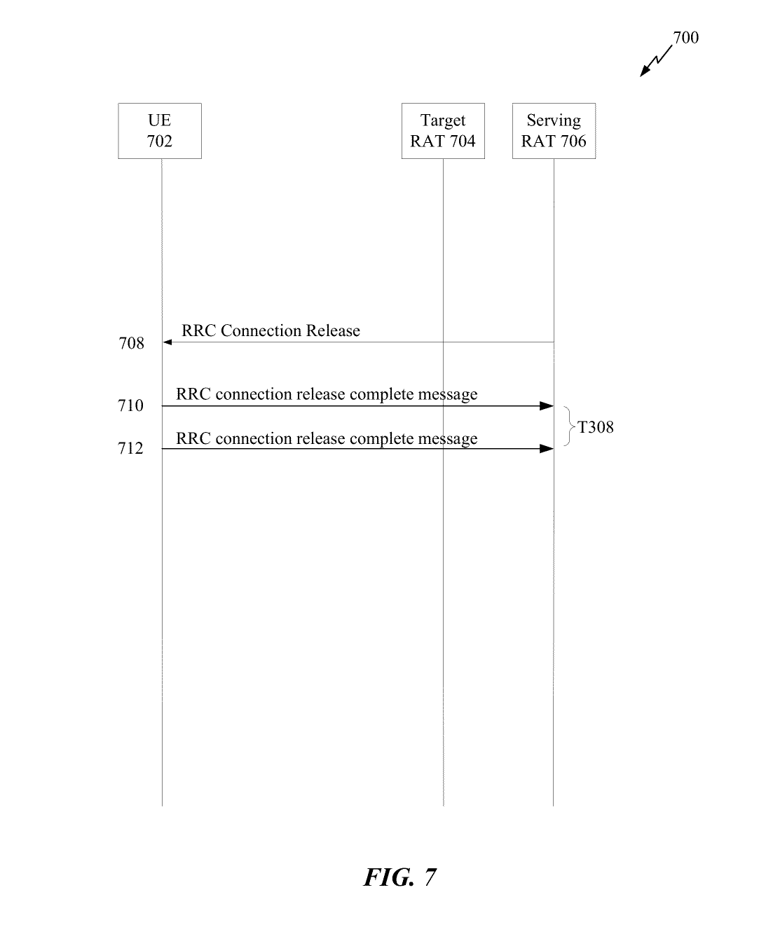

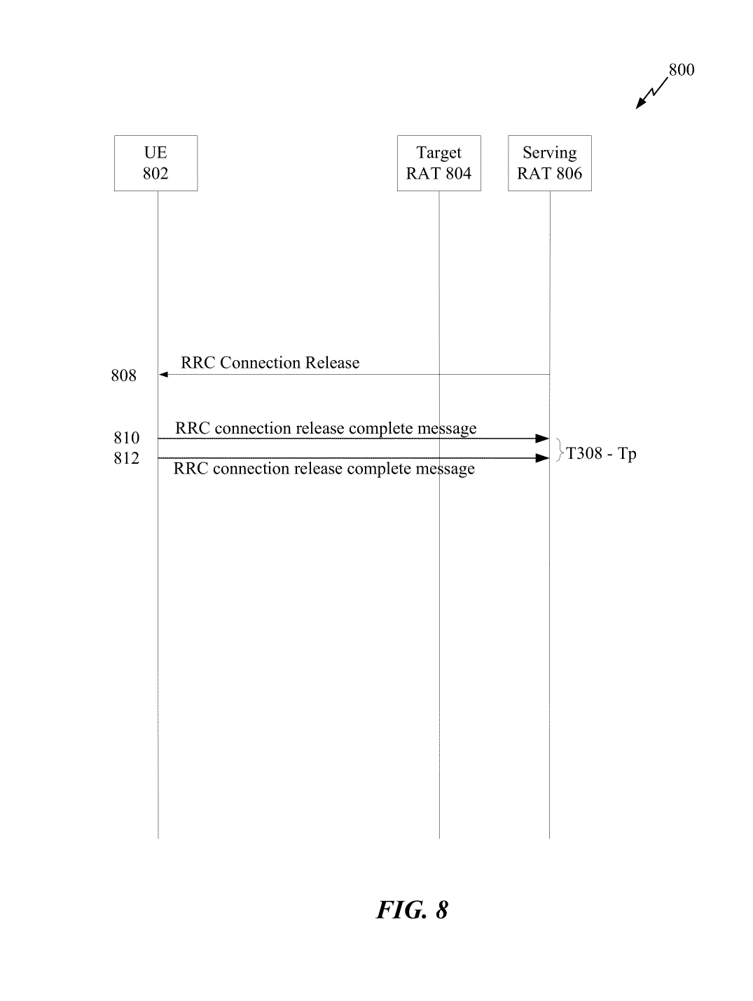

Aspects of the present disclosure seek to reduce latency of the redirection procedure. Exemplary RRC procedures for reducing latency of the redirection are illustrated by FIGS. 7 and 8.

FIG. 7 illustrates call flow 700 of an RRC procedure for reducing latency of redirection according to some aspects of the present disclosure. A UE 702 may receive an RRC connection release message that includes a redirection information indicating a target RAT 704. In one aspect of the present disclosure, the UE 702 performs an alternate RRC connection release procedure that adjusts the number of RRC connection release complete messages. For example, the UE 702 may transmit a reduced number of RRC connection release complete messages to reduce the latency of redirection.

Before the UE 702 moves or camps on the target RAT/frequency/cell 704, the UE 702 completes the RRC procedure. During the RRC procedure the UE 702 receives the RRC connection release message, at time 708, from a serving RAT 706. In response, the UE 702 transmits a reduced number (e.g., 1 or 2) of RRC connection release complete messages (e.g., at times 710, 712) relative to the number of RRC connection release complete messages transmitted in the conventional RRC procedure of FIG. 6. For example, the UE 702 may only transmit one RRC connection release message (e.g., at time 710) before tuning the radio frequency of the UE to the target RAT 704 and performing an acquisition procedure. In one aspect of the present disclosure, the reduced number of RRC connection release complete messages are transmitted with increased transmission power. Transmitting the reduced number of RRC connection release complete messages with increased power helps ensure the RRC connection release complete messages are received.

After expiration of the timer T308, a second RRC connection release message may be sent at time 712. In some aspects of the present disclosure, the delay associated with the timer T308 may also be adjusted. An exemplary RRC procedure for reducing latency of the redirection by adjusting the timer T308 is illustrated by FIG. 8.

FIG. 8 illustrates another call flow 800 of an RRC procedure for reducing latency of redirection by adjusting a time interval (i.e., T308) between RRC connection release messages according to some aspects of the disclosure. In some aspects, the time interval is between consecutive or non-consecutive RRC connection release messages. During the improved RRC procedure, the UE 802 receives the RRC connection release message, at time 808, from a serving RAT 806. In response, the UE transmits RRC connection release complete messages at times 810, 812. The interval between the messages is an adjusted time interval. For example, the time interval between consecutive RRC connection release messages may be reduced by a time value, e.g. time value Tp or may be a fraction of the timer T308. In this aspect, the timer (e.g., T308) is adjusted to reduce the time interval between consecutive RRC connection release messages. The resultant time interval between consecutive RRC connection release messages may be given by T308 less the time value Tp as illustrated in FIG. 8 or a fraction of the timer T308. In some aspects of the disclosure, the latency of redirection may be achieved by reducing the time interval between RRC connection release complete messages in conjunction with reducing the number of RRC connection release complete messages.

Aspects of the present disclosure may allow the UE to perform faster redirection, which reduces latency of the redirection, improving throughput and user perception during redirection. In some aspects of the disclosure, the latency may be reduced by up to one second. The UE can modify the timer and/or number of RRC connection release messages to send. In another aspect, the NodeB reduces the timer and/or number of RRC connection release messages to be sent.

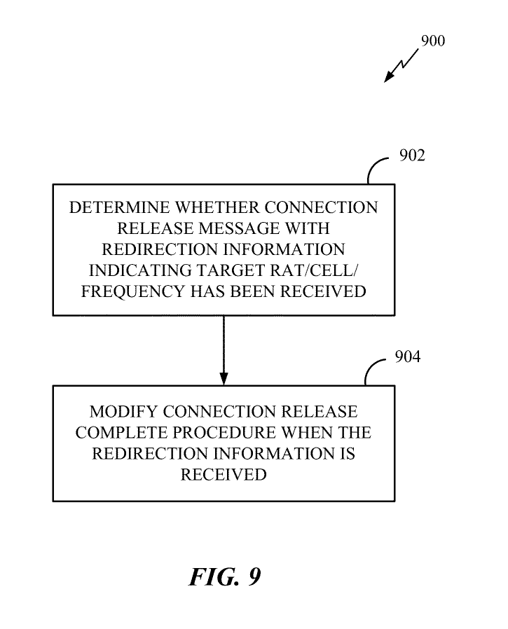

FIG. 9 is a block diagram illustrating a wireless communication method 900 for performing faster redirection according to aspects of the present disclosure. A UE determines whether a connection release message with redirection information indicating a target radio access technology (RAT), a target cell and/or a target frequency has been received, as shown in block 902. In some aspects, the connection release message may be an RRC connection release message. The UE modifies a connection release complete procedure when the redirection information is received, as shown in block 904.

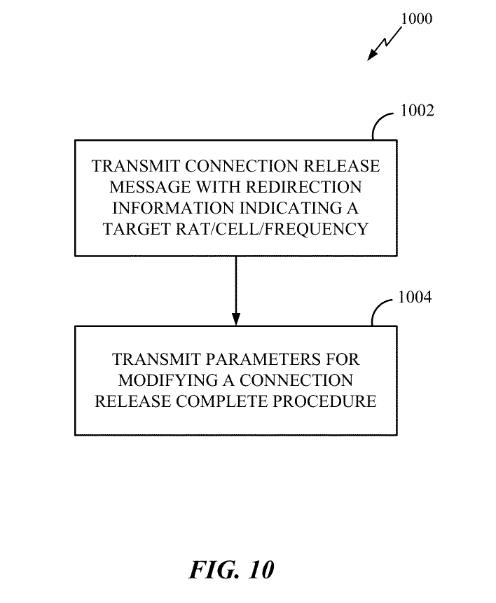

FIG. 10 is a block diagram illustrating another wireless communication method 1000 for performing faster redirection according to aspects of the present disclosure. A base station (e.g., NodeB or eNodeB) transmits a connection release message with redirection information indicating a target RAT, a target cell and/or a target frequency, as shown in block 1002. In some aspects, the connection release message may be an RRC connection release message. The base station transmits parameters for modifying a connection release complete protocol or procedure, as shown in block 1004. In some aspects of the disclosure, the parameters may be part of the redirection information.

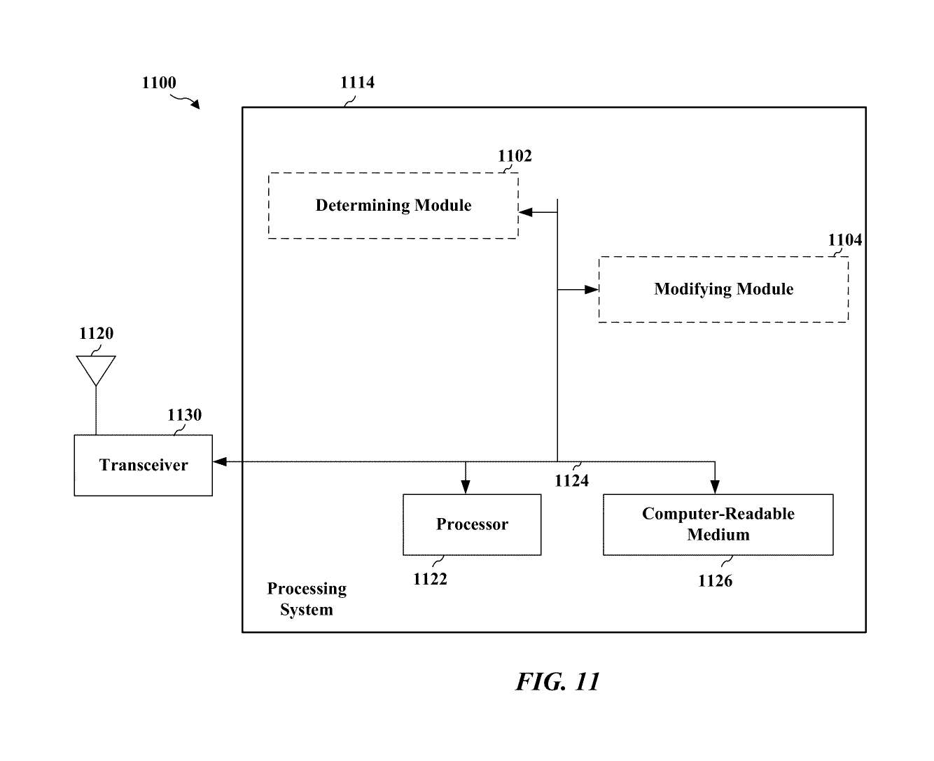

FIG. 11 is a diagram illustrating an example of a hardware implementation for an apparatus 1100 employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122, the determining module 1102, the modifying module 1104, and the computer-readable medium 1126. The bus 1124 may also link various other circuits such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes a determining module 1102 for determining whether a connection release message with redirection information indicating a target radio access technology (RAT), a target cell and/or a target frequency has been received. The processing system 1114 also includes a modifying module 1104 for modifying a connection release complete procedure when the redirection information is received. The modules may be software modules running in the processor 1122, resident/stored in the computer-readable medium 1126, one or more hardware modules coupled to the processor 1122, or some combination thereof. The processing system 1114 may be a component of the UE 350 and may include the memory 392, and/or the controller/processor 390.

In one configuration, an apparatus, such as an UE 350, is configured for wireless communication including means for determining. In one aspect, the above means may be the receiver 354, antenna 352, the receive processor 370, the controller/processor 390, the memory 392, the connection release modifying module 391, the determining module 1102, the processor 1122, and/or the processing system 1114 configured to perform the functions recited by the aforementioned means. In another aspect, the aforementioned means may be a module or any apparatus configured to perform the functions recited by the aforementioned means.

In another configuration, the apparatus configured for wireless communication also includes means for modifying. In one aspect, the above means may be the controller/processor 390, the memory 392, the connection release modifying module 391, the modifying module 1104, the processor 1122, and/or the processing system 1114 configured to perform the functions recited by the aforementioned means. In another aspect, the aforementioned means may be a module or any apparatus configured to perform the functions recited by the aforementioned means.

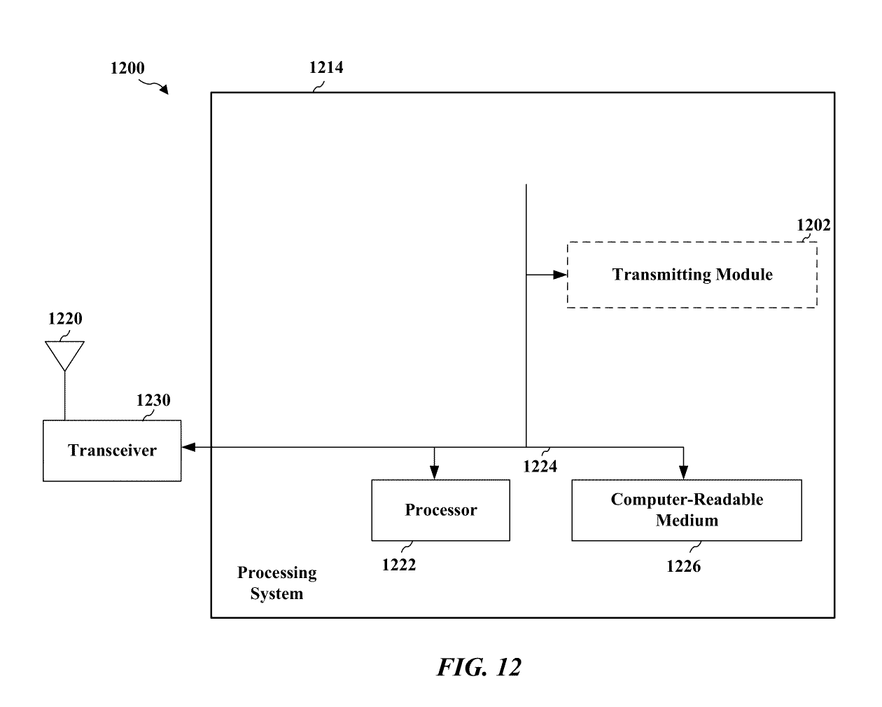

FIG. 12 is a diagram illustrating an example of a hardware implementation for an apparatus 1200 employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222, the transmitting module 1202, and the computer-readable medium 1226. The bus 1224 may also link various other circuits such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatus over a transmission medium. The processing system 1214 includes a processor 1222 coupled to a computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a transmitting module 1202 for transmitting a connection release with redirection information indicating a target RAT, a target cell and/or a target frequency and/or transmitting parameters for modifying a connection release complete procedure. The modules may be software modules running in the processor 1222, resident/stored in the computer-readable medium 1226, one or more hardware modules coupled to the processor 1222, or some combination thereof. The processing system 1214 may be a component of the node B 310 and may include the memory 342, and/or the controller/processor 340.

In one configuration, the apparatus configured for wireless communication also includes means for transmitting. In one aspect, the above means may be the antennae 334/1220, the transmitter 332, transceiver 1230, the transmit processor 320, the controller/processor 340, the memory 342, the connection release modifying module 393, the scheduler/processor 346, the transmitting module 1202, the processor 1222, and/or the processing system 1214 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing global system for mobile communications (GSM), long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a connection release message with redirection information indicating a target radio access technology (RAT), a target cell and/or a target frequency has been received; and
modifying a connection release complete procedure when the redirection information is received.

2. The method of claim 1, in which the modifying comprises decreasing a number of connection release complete messages to be transmitted before stopping communication with serving cell(s) of a source RAT and tuning to the target RAT, target cell and/or target frequency.

3. The method of claim 1, in which the modifying comprises decreasing an interval between transmitting connection release complete messages before stopping communication with serving cell(s) of a source RAT and tuning to the target RAT, target cell and/or target frequency.

4. The method of claim 1, in which the modifying comprises increasing transmit power for transmitting connection release complete messages before stopping communication with serving cell(s) of a source RAT and tuning to the target RAT, target cell and/or target frequency.

5. A method of wireless communication, comprising:
transmitting a connection release message with redirection information indicating a target RAT, a target cell and/or a target frequency; and
transmitting parameters for modifying a connection release complete procedure.

6. The method of claim 5, in which transmitting parameters for modifying comprises transmitting parameters for decreasing a number of connection release complete messages to be transmitted before stopping communication with serving cell(s) of a source RAT and tuning to the target RAT, target cell and/or target frequency.

7. The method of claim 5, in which transmitting parameters for modifying comprises transmitting parameters for decreasing an interval between transmitting connection release complete messages before stopping communication with serving cell(s) of a source RAT and tuning to the target RAT, target cell and/or target frequency.

8. The method of claim 5, in which transmitting parameters for modifying comprises transmitting parameters for increasing transmit power for transmitting connection release complete messages before stopping communication with serving cell(s) of a source RAT and tuning to the target RAT, target cell and/or target frequency.

9. An apparatus for wireless communication, comprising:
a memory; and
at least one processor coupled to the memory and configured:
to determine whether a connection release message with redirection information indicating a target radio access technology (RAT), a target cell and/or a target frequency has been received; and
to modify a connection release complete procedure when the redirection information is received.

10. The apparatus of claim 9, in which the at least one processor is further configured to modify by decreasing a number of connection release complete messages to be transmitted before stopping communication with serving cell(s) of a source RAT and tuning to the target RAT, target cell and/or target frequency.

11. The apparatus of claim 9, in which the at least one processor is further configured to modify by decreasing an interval between transmitting connection release complete messages before stopping communication with serving cell(s) of a source RAT and tuning to the target RAT, target cell and/or target frequency.

12. The apparatus of claim 9, in which the at least one processor is further configured to modify by increasing transmit power for transmitting connection release complete messages before stopping communication with serving cell(s) of a source RAT and tuning to the target RAT, target cell and/or target frequency.

13. An apparatus for wireless communication, comprising:
a memory; and
at least one processor coupled to the memory and configured:
to transmit a connection release message with redirection information indicating a target RAT, a target cell and/or a target frequency; and
to transmit parameters for modifying a connection release complete procedure.

14. The apparatus of claim 11, in which the at least one processor is further configured to transmit parameters for decreasing a number of connection release complete messages to be transmitted before stopping communication with serving cell(s) of a source RAT and tuning to the target RAT, target cell and/or target frequency.

15. The apparatus of claim 11, in which the at least one processor is further configured to transmit parameters for decreasing an interval between transmitting connection release complete messages before stopping communication with serving cell(s) of a source RAT and tuning to the target RAT, target cell and/or target frequency.

16. The apparatus of claim 11, in which the at least one processor is further configured to transmit parameters for increasing transmit power for transmitting connection release complete messages before stopping communication with serving cell(s) of a source RAT and tuning to the target RAT, target cell and/or target frequency.
